(19) United States
(12) Patent Application Publication
(10) Pub. No.: US 2007/0234965 A1
(43) Pub. Date: Oct. 11, 2007

(54) Edible pet container

(76) Inventors: Teresa A. Aguilar, Dallas, TX (US); Dan Jager, Plainwell, MI (US)

Correspondence Address: MICHAEL L. DIAZ, P.C., 555 REPUBLIC DRIVE, SUITE 200, PIANO, TX, 75074, US

(21) Appl. No.: 11/399,779

(22) Filed: Apr. 7, 2006

(51) Int. Cl. A01K 5/01

(52) U.S. Cl. 119/61.5

(57) ABSTRACT

A feeding system providing a pet container holding a frozen or liquid pet food. The feeding system includes a pet container having a bottom section and a wall extending from a perimeter of the bottom section to a top section. The bottom section and wall form an interior holding pet food which may be a liquid or frozen substance. The top section is open to allow access to the interior. The bottom section and wall are constructed of an edible material preventing a liquid substance or a frozen substance from passing through the pet container.

### BACKGROUND OF THE INVENTION

1. Field of the Invention

This invention relates to pet feeding systems. Specifically, and not by way of limitation, the present invention relates to an edible pet container holding pet food within the container.

2. Description of the Related Art

There are millions of pet owners across the nation caring and feeding for various types of animals. Obviously, one of the most important duties of a pet owner is the feeding of the pet. There are a wide variety of foods available for pets. In addition, there are existing edible food containers which are capable of holding dried pet food. But there are no containers capable of holding a pet food having a liquid or frozen consistency. Pet foods are now available which provide foods in the liquid and frozen state. It would be advantageous to have a container capable of holding a liquid or frozen food without leaking the food from the container.

Although there are no known prior art teachings of a solution to the aforementioned deficiency and shortcoming such as that disclosed herein, a prior art reference that discusses subject matter that bears some relation to matters discussed herein is U.S. Pat. No. 5,346,710 to Geitner (Geitner). Geitner discloses an animal feeding system having a bowl constructed of an edible material carrying dry animal food. Although Geitner discloses constructing the bowl out of an edible material, the container is not capable of holding a liquid or frozen material without leaking the contents from the bowl.

Thus, it would be a distinct advantage to have an edible container which is capable of securing holding frozen or liquid contents. It is an object of the present invention to provide such an apparatus.

### SUMMARY OF THE INVENTION

In one aspect, the present invention is a pet container for holding pet food. The pet container has a bottom section and a wall extending from a perimeter of the bottom section to a top section. The bottom section and wall form an interior for holding and storing the pet food. The top section is opened to allow access to the interior and the pet food. The bottom section and wall are constructed of an edible material preventing a liquid substance from passing through the pet container. The pet food is then held in the interior of the container.

In another aspect, the present invention is a feeding system providing a pet container holding a frozen or liquid pet food. The feeding system includes a pet container having a bottom section and a wall extending from a perimeter of the bottom section to a top section. The bottom section and wall form an interior holding pet food which may be a liquid or frozen substance. The top section is open to allow access to the interior. The bottom section and wall are constructed of an edible material preventing a liquid substance or a frozen substance from passing through the pet container.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a top view of a pet container in the preferred embodiment of the present invention;

FIG. 2 is a bottom view of the pet container of FIG. 1; and

FIG. 3 is a partial cross sectional side view of the pet container holding pet food in the preferred embodiment of the present invention.

### DESCRIPTION OF THE INVENTION

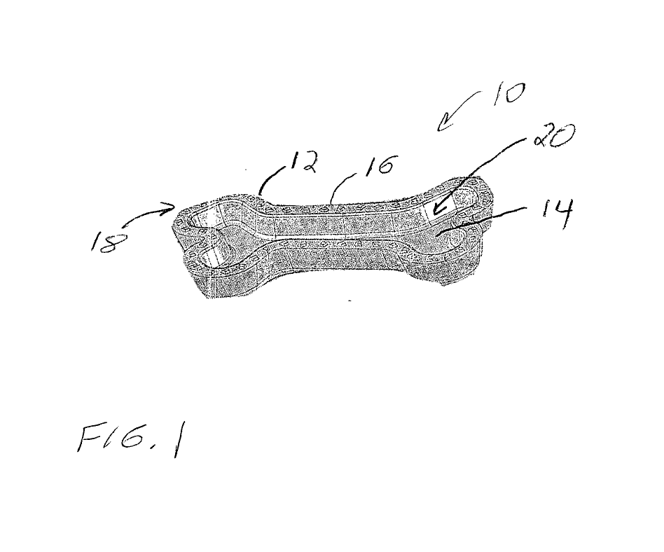

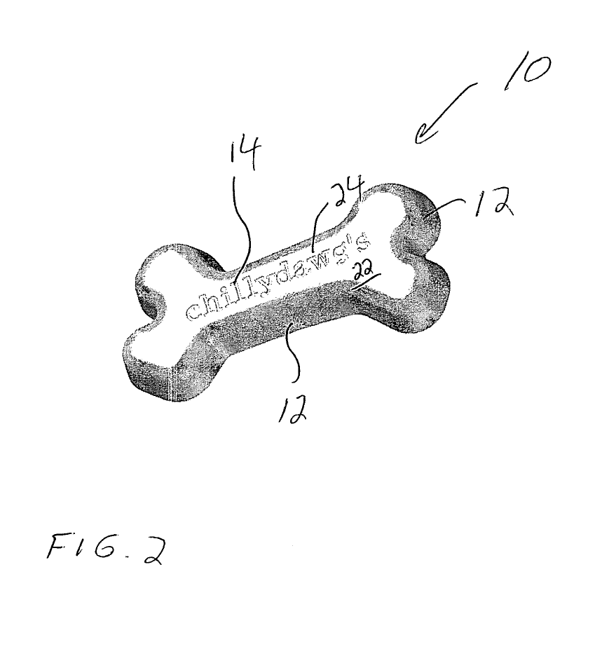

An edible pet container is disclosed. FIG. 1 is a top view of a pet container 10 in the preferred embodiment of the present invention. FIG. 2 is a bottom view of the pet container 10 of FIG. 1. The pet container includes walls 12 and a bottom portion 14. The walls have an approximately uniform height X and originate from the bottom portion of the pet container to a rim 16 located at a top section 18 of the pet container. The walls and bottom portion form the boundaries of an interior area 20 for storing the pet food. The top section 18 is open to allow access to the contents of the pet container by the pet. The pet container may be in any shape or size. As illustrated, the pet container is in the shape of a bone. In an alternate embodiment, the pet container is bowl-shaped. In addition, the bottom surface 22 of the bottom portion of the container may include a logo or name brand 24 engraved to the surface.

The walls 12 and the bottom portion 14 of the pet container are edible and capable of holding a liquid or a frozen product, such as an ice cream type treat. Although not limited to the follow ingredients, in the preferred embodiment of the present invention, the walls and bottom portion may include various starches such as corn starches, wheat starches, potato starches, rice starches, or tapioca starches. Additionally, the walls and bottom portion include starches such as high-amylose starches, modified starches, waxy starches, dent starches, or native starches. A plastising agent may be utilized from the following group: glycerin, propylene glycol, corn syrups, sorbitol, and other various sugars. Preservative systems may be included such as potassium sorbate and sorbic acid. The walls and bottom portion may include macro minerals from the following group: sodium, calcium carbonate, phosphorus, magnesium, potassium, sulfur, and chloride. In addition, trace elements may be used such as iron, zinc, iodine, selenium, copper, manganese, fluoride, chromium, molybdenum, and iodine. Non-essential trace minerals may include boron, silicon, and vanadium. Fibers which may be utilized include cellulose fibers and vegetable fibers. Other ingredients may include anti-oxidants, nutriceuticals, vitamins, suggested aids for cartilage development (glucosamine, condroitin, etc.), emulsifiers (used as processing agents), and phytonutrients.

To add to the taste of the walls, vegetables (e.g., peas, carrots, potatoes, onions, garlic, tomatoes, celery, cucumber, broccoli, spinach), both dried and fresh may be included as ingredients to the walls and bottom portion of the pet container. Additionally, other natural and artificial coloring systems and flavors may be added.

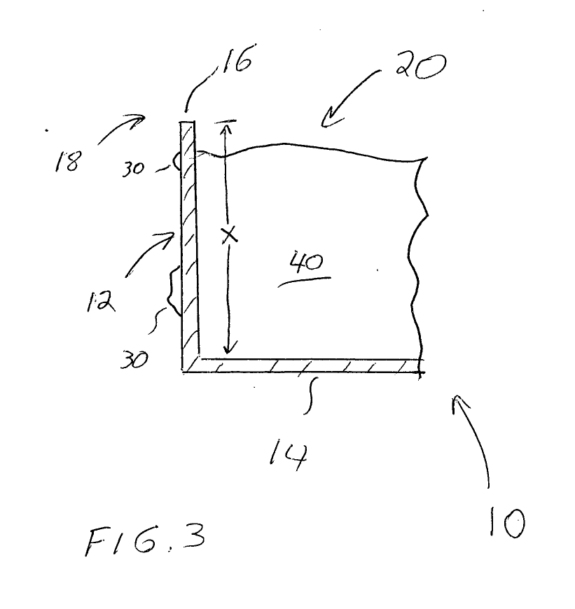

The walls 12 and bottom portion 14 are preferably utilized as an edible chew providing extending chewing for the pet. In the preferred embodiment of the present invention, the walls and bottom portion include ridges 30 (FIG. 3) or other surface irregularities which provide an abrasive quality to the wall to assist in cleaning the pet's teeth as well as freshening the breath of the pet.

FIG. 3 is a partial cross sectional side view of the pet container 10 holding pet food 40 in the preferred embodiment of the present invention. The pet food may be any product. However, in the preferred embodiment of the present invention, the pet food is a substance, unlike dried pet food, which normally is not contained in a conventional pet container. Rather, the pet container is capable of holding fluids (e.g., gravy), frozen products (e.g., frozen treats such as ice cream type or frozen liquids), or other soft products (e.g., pudding or yogurt). The walls and bottom portion are constructed of a material which prevents the pet food from leaking through the material.

The pet food 40 may be sold and stored within the pet container 10 or sold separately. For example, a liquid may be utilized which is poured within the interior portion 14 of the pet container when ready to serve to the pet. The pet food may also be poured into the pet container and then frozen for use at a later time. In addition, it should be understood that the pet container may hold a liquid having a semi-solid consistency, such as a paste, gravy, yogurt, or ice cream.

The present invention provides many advantages over existing products. The present invention provides a pet container capable of holding liquids, soft food products and frozen food products. The pet container may be frozen to provide a frozen treat for a pet. In addition, the walls and bottom portion are edible. The pet container may be utilized as a pet chew and assist in the cleaning of the pet's teeth and freshening of the breath of the pet.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A pet container for holding pet food, the pet container comprising:
a bottom section and a wall extending from a perimeter of the bottom section to a top section;
the bottom section and wall forming an interior for holding and storing the pet food;
the top section being open to allow access to the interior and the pet food; and
the bottom section and wall being constructed of an edible material preventing a liquid substance from passing through the pet container;
whereby pet food is held in the interior of the container.

2. The pet container for holding pet food of claim 1 wherein the pet food is a liquid substance.

3. The pet container for holding pet food of claim 1 wherein the pet food is a frozen substance.

4. The pet container for holding pet food of claim 1 wherein the wall includes a plurality of irregularities, the irregularities providing an abrasive quality for cleaning teeth of the pet eating the pet container.

5. The pet container for holding pet food of claim 1 wherein the wall and bottom section are a chew material allowing the pet to chew the chew material for an extended time period.

6. The pet container for holding pet food of claim 1 wherein the perimeter of the pet container is bone-shaped.

7. A feeding system having a pet container holding pet food, the feeding system comprising:
a pet container having:
a bottom section and a wall extending from a perimeter of the bottom section to a top section;
the bottom section and wall forming an interior;
the top section being open to allow access to the interior; and
the bottom section and wall being constructed of an edible material preventing a liquid substance from passing through the pet container; and
pet food stored in the interior.

8. The feeding system of claim 7 wherein:
the pet food is a liquid substance; and
the pet container and pet food is frozen prior to serving to the pet.

9. The feeding system of claim 7 wherein the pet food is a frozen treat.

10. The feeding system of claim 7 wherein the pet food is a pudding substance.

11. The feeding system of claim 7 wherein the pet food is a liquid substance.

12. The feeding system of claim 7 wherein the wall includes a plurality of irregularities, the irregularities providing an abrasive quality for cleaning teeth of the pet eating the pet container.

13. The feeding system of claim 7 wherein the wall and bottom section are a chew material allowing the pet to chew the material for an extended time period.

14. The feeding system of claim 7 wherein the perimeter of the pet container is bone-shaped.

15. The feeding system of claim 7 wherein the pet food is a liquid substance that has a semi-solid consistency.

16. A feeding system having a pet container holding pet food, the feeding system comprising:
a pet container having:
a bottom section and a wall extending from a perimeter of the bottom section to a top section;
the bottom section and wall forming an interior;
the top section being open to allow access to the interior; and
the bottom section and wall being constructed of an edible material preventing a liquid substance or a frozen substance from passing through the pet container; and
frozen pet food stored in the interior.
